(19) United States
(12) Patent Application Publication
(10) Pub. No.: US 2012/0002405 A1
(43) Pub. Date: Jan. 5, 2012

(54) ILLUMINATING BOOK LIGHT WITH ATTACHABLE HEADS

(75) Inventors: David Nelson, Las Vegas, NV (US); Wai-Ming Law, Yuen Long (HK); Clifford Krapfl, Chicago, IL (US); Bjorn Gunderson, Chicago, IL (US); Michael A. Serafin, Downers Grove, IL (US)

(73) Assignee: SOL-LIGHT, LLC., Las Vegas, NV (US)

(21) Appl. No.: 12/830,222

(22) Filed: Jul. 2, 2010

(51) Int. Cl. F21L 4/04; F21S 4/00

(52) U.S. Cl. 362/191; 362/249.07; 362/249.11

(57) ABSTRACT

An illuminating device having multiple adjustable housings is described. Each head has one or more light sources. Each head each may be attached to a neck that extends from a base. The light sources may be manipulated into numerous positions to focus on different areas or may be joined together via a removable attachment to focus on a single area. Such an illuminating device may be desirable for use, for example, as a portable illuminator, a book light, or a travel light.

### FIELD

The illustrative embodiments disclosed herein are generally directed to portable illuminating devices. More particularly, the illustrative embodiments disclosed herein pertain to low light illuminators including book lights.

### BACKGROUND

Portable illuminators are useful in providing lighting to specific areas on a temporal basis. Certain portable illuminators can be affixed to objects thereby eliminating the need for the user to hold the light in order to use the light emitted. An example of portable illuminator may be a book light. Book lights often have a clip for clipping to a book and a light extending from the clip. The light may typically be positioned when manipulated by a user. Portable illuminators such as book lights are normally used in low light environments.

### SUMMARY

One illustrative embodiment disclosed herein pertains to individual light heads that are removably coupled to one another. In this illustrative embodiment, an illuminating device has a first housing with a first light source therein and a second housing with a second light source therein. The illuminating device also includes a base that is configured to permit removable attachment to an article. The first housing and the second housing are connected to the base via a first neck and a second neck. The first neck and the second neck enable the first housing and the second housing to be adjustably positioned with respect to the base. The first housing and the second housing are also configured to be removably attached to each other such that the first light source and the second light source can form a unitary light source or be separately focused on one or more areas.

Another illustrative embodiment disclosed herein includes an illuminating device having first and second housings, each with a light source therein, and a base configured to permit removable attachment to an article. First and second necks are each attached at one respective end to the base and at the opposite end to one of the housings. The first and second housing are configured to be removably coupled to each other to enable movement of the first and second housing together when coupled, and to be individually manipulated when uncoupled.

Another illustrative embodiment disclosed herein includes an illuminating device having first and second housings, each with a light source therein, and a base including a battery operatively connected to the light sources, and a user-engagable control switch. Flexible first and second necks are each attached at one respective end to the base and at the opposite end to one of the housings. The respective necks enable the housings to be adjustably positioned with respect to the base and with respect to the other housing. An attachment system removably couples the first housing to the second housing.

Yet, another illustrative embodiment disclosed herein includes an illuminating device having a base, first and second housings, and first and second necks. Each of the housings includes a light source and a coupling element. The base has clamp for removably clamping an article there between. The first neck is attached at a first end to the first housing and at a second end to the base. The second neck is attached at a first end to the second housing and at a second end to the base. Each neck has a length between 3 and 10 inches, and enables its respective housing to be adjustably positioned with respect to the base. The coupling elements of the first and second housing selectively permit the coupling and decoupling of the first and second housing to each other, and thereby enable movement of the first and second housing together when coupled, and to be individually manipulated when decoupled.

### BRIEF DESCRIPTION OF THE DRAWINGS

A more complete understanding of the embodiments disclosed herein and the advantages thereof may be acquired by referring to the following description in consideration of the accompanying drawings, in which like reference numbers indicate like features, and wherein:

FIG. 1A is a top view of an illustrative illuminating device with its first and second heads in a first position relative to each other.

FIG. 1B is a top view of the illuminating device with its first and second heads in a second position relative to each other.

FIG. 2A is a bottom view of the illuminating device with its first and second heads in the first position relative to each other as shown in FIG. 1A.

FIG. 2B is a bottom view of the illuminating device with its first and second heads in the second position relative to each other as shown in FIG. 1B.

FIG. 2C is an enlarged schematic view showing details of an illustrative head coupling system of the illuminating device.

FIG. 3A is a right side view of the illuminating device with its first and second heads in the first position relative to each other as shown in FIG. 1A.

FIG. 3B is a left side view of the illuminating device with its first and second heads in the first position relative to each other as shown in FIG. 1A.

FIG. 4A is a top view of an illustrative illuminating device with its first and second heads in a second position relative to each other similar to FIG. 1B including an alternate head coupling system arrangement.

FIG. 4B is a top view of an illustrative illuminating device with its first and second heads in a second position relative to each other similar to FIG. 1B and

FIG. 4A including another alternate head coupling system arrangement.

FIGS. 4C and 4D are enlarged schematic sectional views details of the illustrative head coupling system shown in FIG. 4B.

FIG. 5A is a top view of an alternative illuminating device with its first, second, and third heads in a first position relative to each other.

FIG. 5B is a top view of the illuminating device of FIG. 5A with its first, second, and third heads in a second position relative to each other.

### DETAILED DESCRIPTION

In the following description of the various embodiments, reference is made to the accompanying drawings. It is to be understood that other embodiments may be utilized and structural and functional modifications may be made without departing from the scope of the invention.

Overall Device

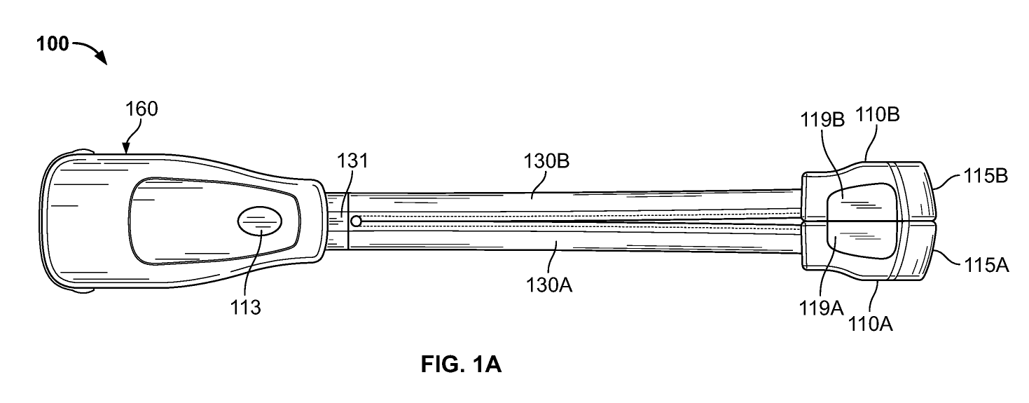

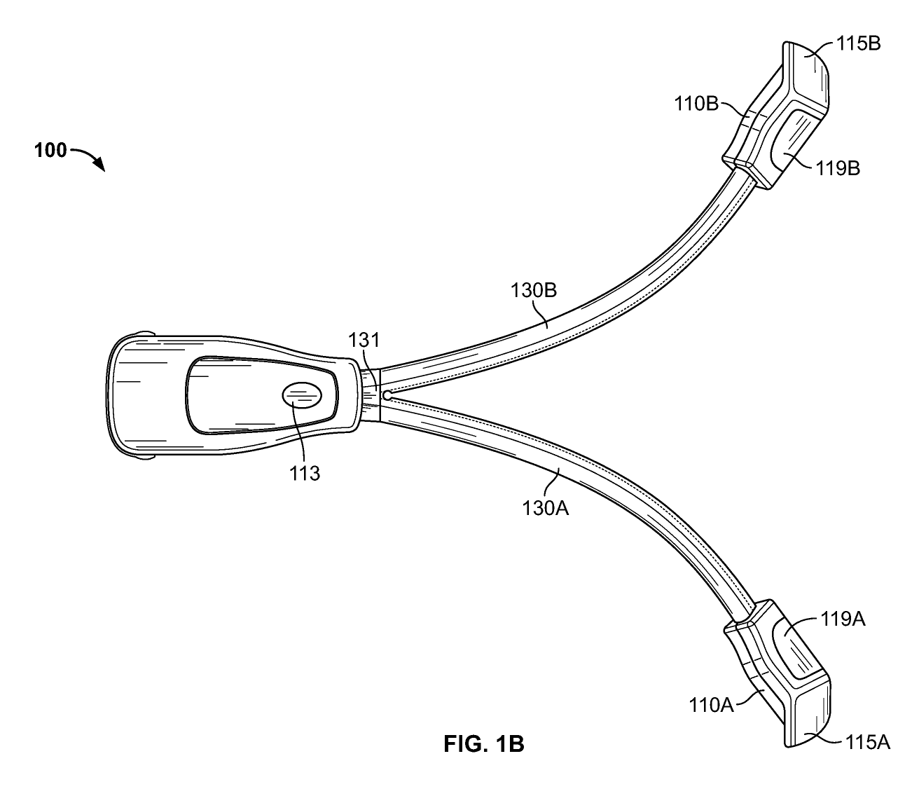

FIGS. 1A-3B depict an illustrative embodiment of an illuminating device 100.

The depicted illuminating device 100 includes a first head 110A, a second head 110B, a first neck 130A, a second neck 130B, and a base 160. The first neck 130A enables the first head 110A to be adjustably positioned relative to the base 160 and adjustably positioned relative to the second head 110B. Likewise, the second neck 130B enables the second head 110B to be adjustably positioned relative to the base 160 and adjustably positioned relative to the first head 110A. Each of the heads, 110A and 110B includes at least one illumination member, such as a light emitting diode (LED). When illuminated, each head inherently has illumination characteristics, such as the concentration, spread, and direction of the emitted light, formed in part by the number of its illumination members, their position relative to each other, and any lenses and secondary optics.

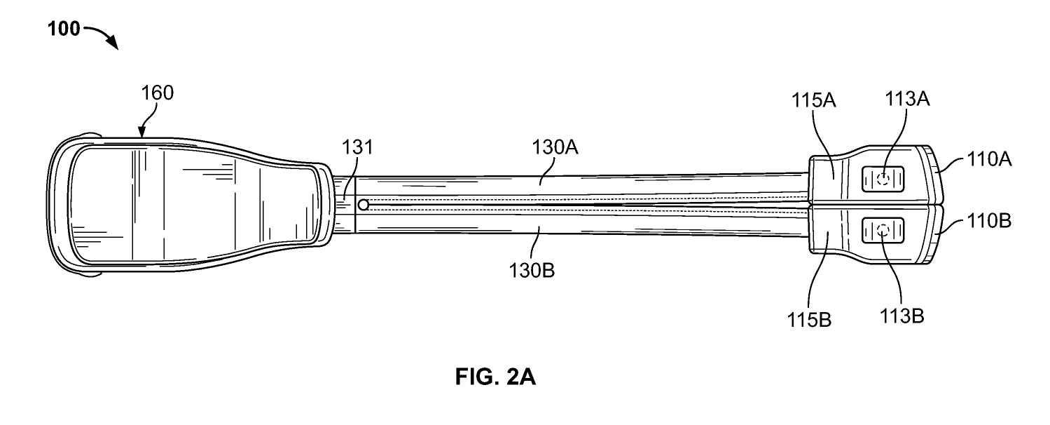

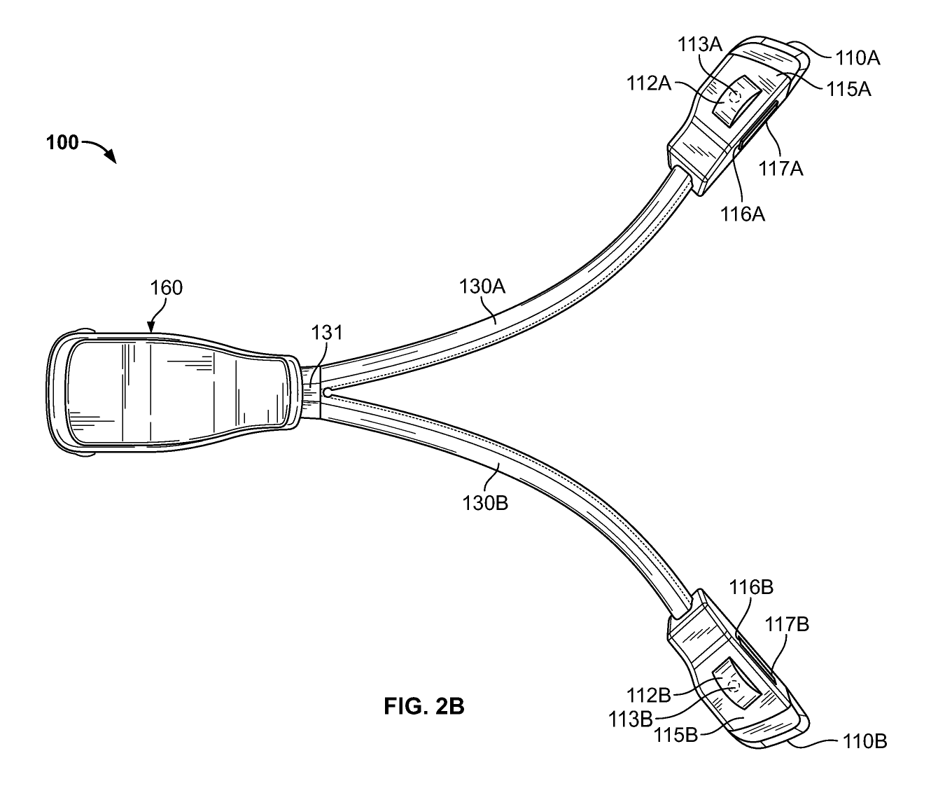

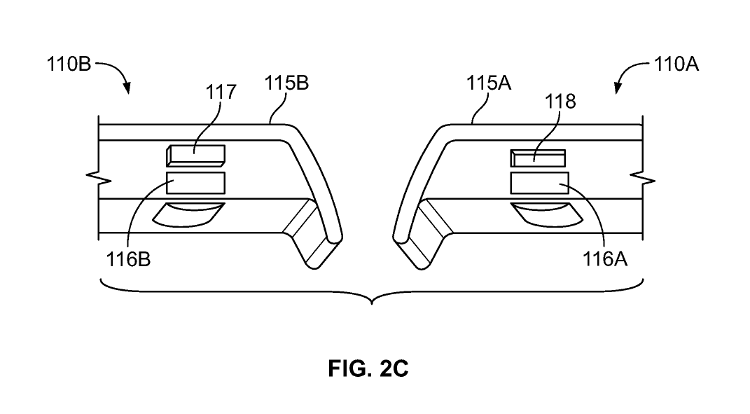

In the illustrative embodiments, the illuminating device 100 is provided with a head coupling system such that the first head 110A and the second head 110B can be removably coupled together. When the first and second heads 110A and 110B are coupled together, as is shown for example in FIGS. 1A and 2A, the first and second heads 110A and 110B illuminate an area according to their combined illumination characteristics. That is, when the first and second heads 110A and 110B are coupled to each other, the positions of the heads 110A and 110B are fixed relative to each other, and the illumination characteristics of the first head and the illumination characteristics of the second head illuminate an area according to a predetermined illumination characteristic formed by the combination of the first and second heads. The necks 130A and 130B enable the coupled heads 110A and 110B to be manipulated as a single lighting unit to direct the light from the combined illumination characteristic at an area of choice by the user.

The removable head coupling system also enable the heads 110A and 110B to be separated or decoupled from each other as is shown in FIGS. 1B and 2B. This enables the user to individually manipulate the heads 110A and 110B as desired. This enables the user to individually direct each head 110A and 110B with their respective illumination characteristics toward distinct areas or towards a common area.

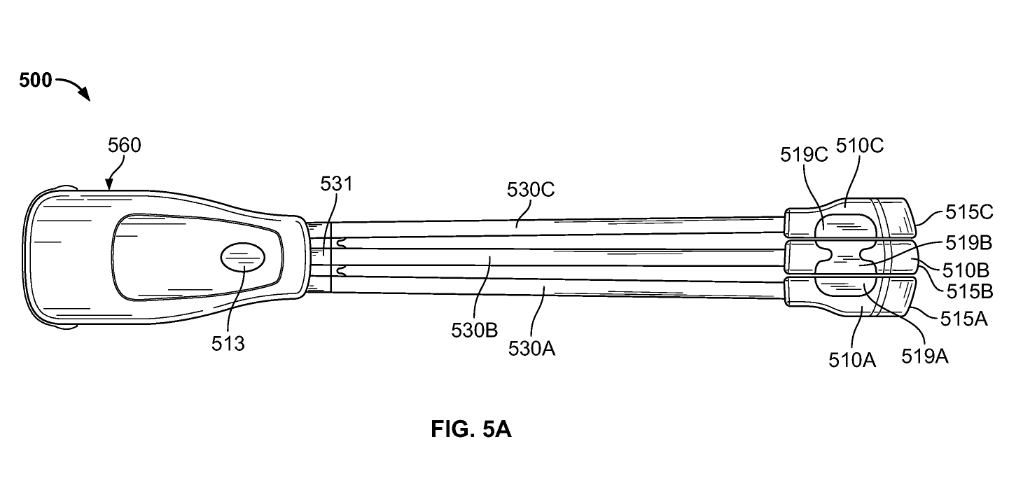

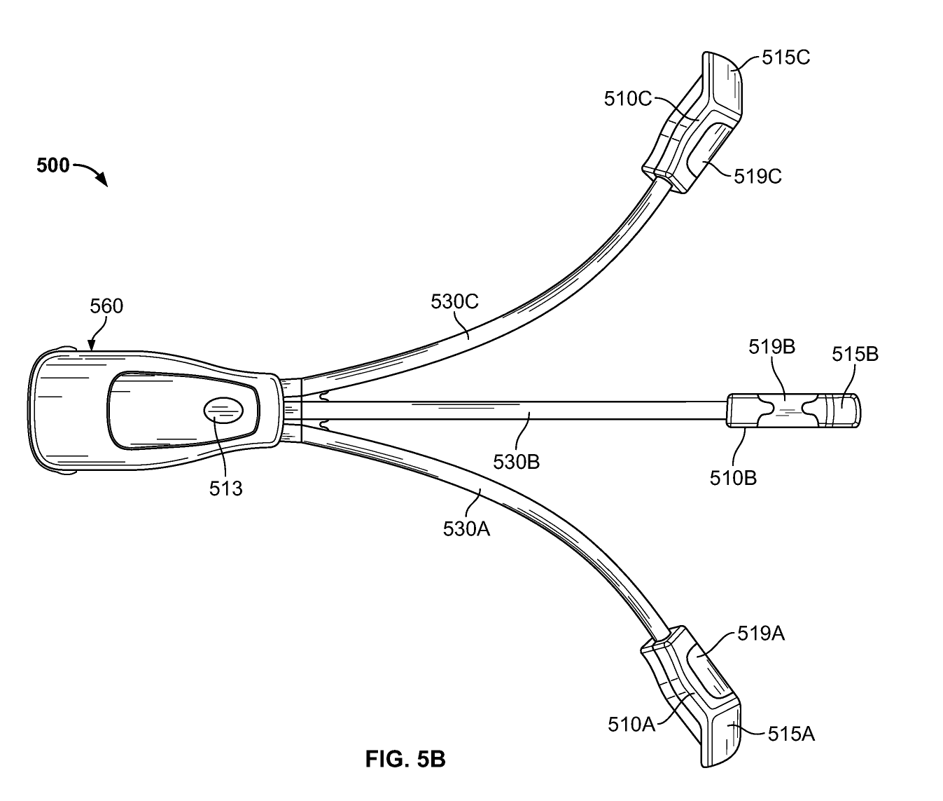

While the arrangements of the illuminating device 100 shown in FIGS. 1A-4B depict two heads, any number of heads with light sources and corresponding necks are contemplated. For example, in the embodiment depicted in FIGS. 5A and 5B, and as described in more details hereinafter, three heads with respective necks are used.

### Head Structures

The first head 110A includes a first housing 115A that has a first light source, and the second head 110B includes a second housing 115B that has a second light source. The light sources are schematically illustrated in FIGS. 1B and 2B by reference numerals 111A and 111B, respectively. In an illustrative arrangement, the light sources take the form of at least one illuminating member (e.g., a LED).

In an illustrative arrangement as shown in the figures, both of the first housing 115A and the second housing 115B include sections 112A, 112B that have light transmittable properties (hereinafter “transparent sections”). The sections 112A, 112B may be formed of translucent, transparent or semi-transparent/translucent material, such as a suitable plastic, depending upon desired preferences and may allow the light emitted by the illumination member or members 111A, 111B to transmit there through.

At least one light source 111A is located inside the first housing 115A behind the transparent section 112A. Additionally, at least one light source 111B is located inside the second housing 115B behind the transparent section 112B. If desired, the transparent sections 112A and 112B may be shaped, for example like a lens, to have optical properties to distribute or concentrate the light rays. Accordingly, when the light sources are on, light emitted from the light sources 111A, 111B transmits through its respective transparent section 112A, 112B to the illuminate an area according to its illumination characteristics.

Head Coupling Systems

As shown in FIGS. 1A and 2A, the first housing 115A and the second housing 115B are configured to attach to each other to effectively form a combined illumination housing formed by the joined first and second housings 115A and 115B. When this occurs, it results in producing a predetermined illumination characteristic formed by the combination of those heads. Accordingly, the heads 110A and 110B move together and can be commonly adjusted to direct the emitted light in a location as desired by the user.

In the illustrative embodiment shown in FIGS. 1A-1B, 2A-2C, and 3A-3B, a magnetic coupling system is used to enable the first and second heads 110A and 110B to be removably coupled. In this embodiment a magnet is used on the side of one of the heads that faces the adjacent head. The adjacent side of the adjacent head includes either a magnet attracting metal, such as an iron, nickel or cobalt, or another magnet with its poles oriented to create an attraction force with the magnet of the other head. As best shown in FIGS. 2B and 2C, the first head 110A includes a first magnet 116A and the second head 110B includes a second magnet 116B. When the inside surfaces of the first and second housings 115A and 115B are moved against each other, a magnetic attraction force is created to hold the first and second housings 115A, 115B together. The attraction force is small sufficiently small enough such that a small intended threshold force by the user can separate the first and second housings 115A, 115B, but the force is sufficient enough to keep the first and second housings 115A, 115B coupled to form a unitary lighting assembly that can be commonly manipulated as to direction and position with respect to the base 160.

Additionally, as best seen in FIG. 2C, a head-to-head alignment system can be used to aid in the coupling of the heads 110A and 110B together. This assists in the accurate alignment between the two heads and can be used to reduce the tolerances in achieving the desired combined illumination properties with the heads together. In one embodiment, as shown, this is achieved by the use of an alignment projection 117 located on one either one of the housings, and a complementary shaped alignment groove 118 located on the other housing. When coupled, the projection/groove also serves to hold the heads together negating forces to the coupled heads that are in a direction other than perpendicular to the adjacent faces. The head-to-head coupling and alignment systems need not be formed by discrete features and can be combined, if desired, by making the projection 117 and the corresponding groove 118 (or the region adjacent the groove 118) magnets or one magnet and the other a magnetic attracting metal to create the previously described attraction force.

In addition, a visual alignment system may be used. In one arrangement, the visual alignment system is located on the side of the housings 110A and 110B opposite from the illumination members 111A, 111B and transparent sections 112A, 112B. That is, if the heads 110A, 110B are manipulated so to emit light downward, each the top surfaces of the heads 110A and 110B include at least one visual alignment feature that extends to or adjacent its side near the adjacent head that provides a visual guide in helping the user quickly and properly align and couple the heads 110A and 110B. In one embodiment, this alignment feature is formed by surface ornamentation or a contrast of coloring or finishes. One example of the visual alignment features is shown in FIGS. 1A and 1B. In this illustrative embodiment, a center region 119A and 119A on each of the top surfaces of the heads 110A and 110B includes a contrasting region to its surrounding area. This aids the user to quickly and accurately couple the heads 110A and 110B as shown in FIG. 1A.

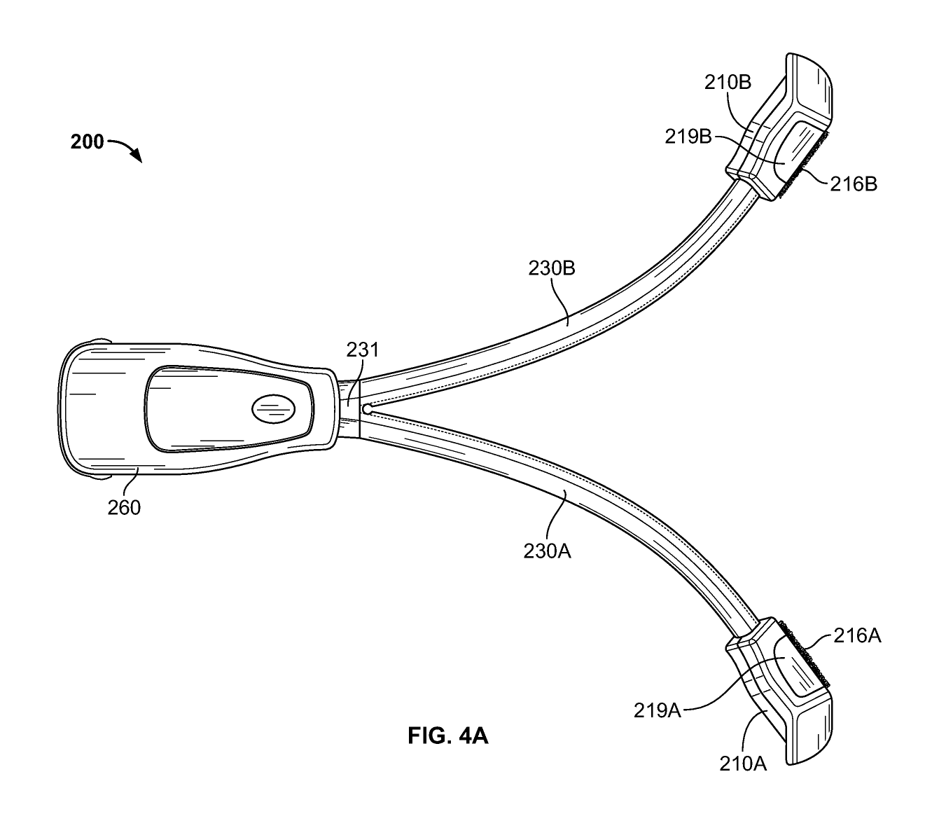

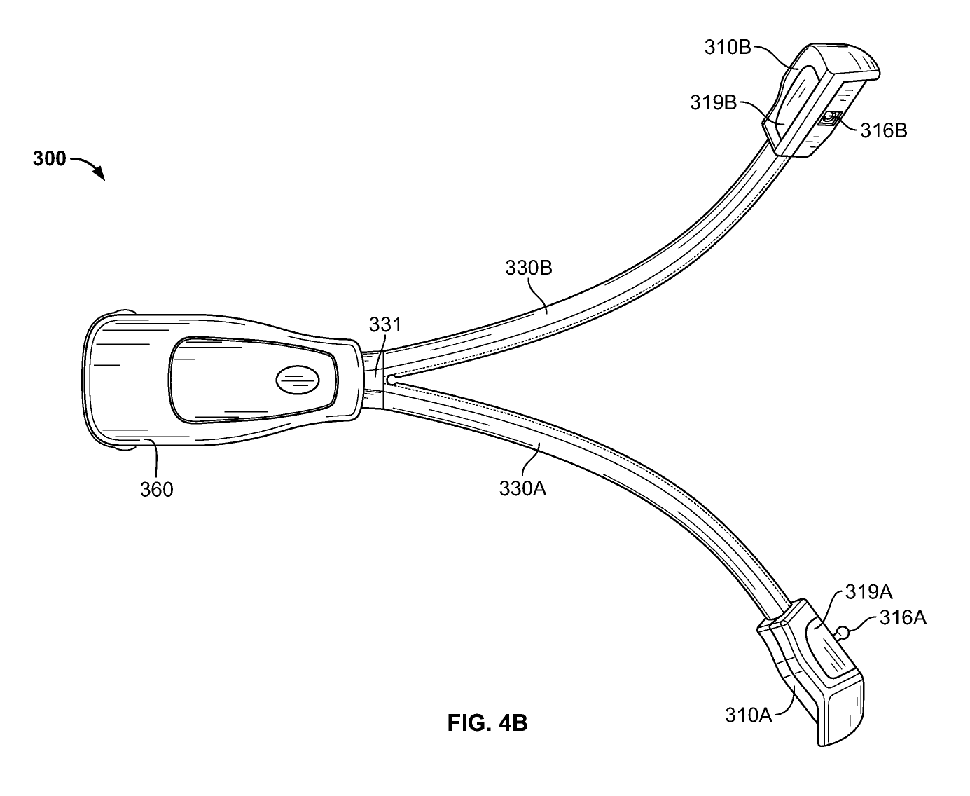

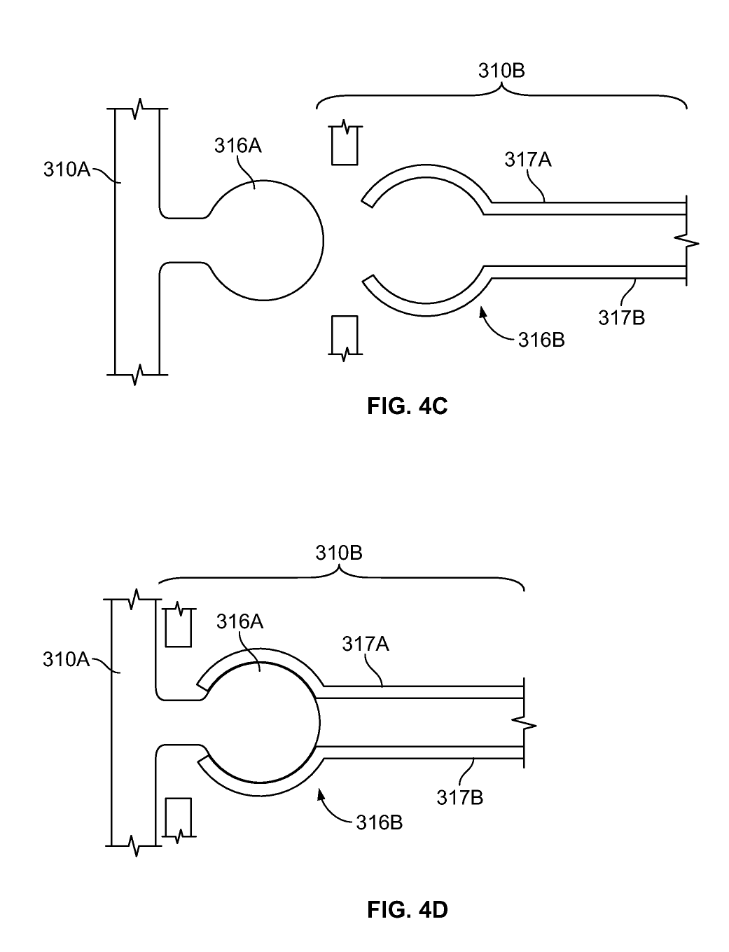

The connection between the housings can be accomplished through the use of any desirable coupling method in lieu of a magnetic coupling system as previously described. FIGS. 4A and 4B depict alternative structures that can be used to connect the housings 115A, 115B. Similar reference numerals with different numerals in the hundreds digit are used to depict the various components on each embodiment shown in FIGS. 4A and 4D as has been used in FIGS. 1A-3B.

FIG. 4A shows a head coupling system formed by hook and loop connection 216A, 216B (e.g., VELCRO). To facilitate this, one half 216A of a hook and loop coupling is attached to the inner surface of the first head 210A and the other half 216B of the hook and loop coupling is attached to the inner surface of the second head 210B. If desired, the hook and loop coupling elements 216A and 216B may be slightly recessed to more effectively use the alignment systems as previously described. This can be used an alternative connection or in addition to other attachment structures. This embodiment can also include all of the components of the embodiment depicted in FIGS. 1A-3B. For example, the depicted illuminating device 200 may include a first head 210A, a second head 210B, a first neck 230A, a second neck 230B, and a base 260. Similar to the embodiment shown in FIGS. 1A-3B, the first neck 230A enables the first head 210A to be adjustably positioned relative to the base 260. Likewise, the second neck 230B enables the second head 210B to be adjustably positioned relative to the base 260 and the first head 210A. Additionally, the top surfaces of the heads 210A and 210B include at least one visual alignment feature that extends to or adjacent its side near the adjacent head that provides a visual guide in helping the user quickly and properly align and couple the heads 210A and 210B as previously described.

Alternatively, as shown in FIG. 4B, a snap fit coupling system may be used as an alternative connection or in addition to other attachment structures. To facilitate this, one half of a snap fit coupling, e.g., sphere shaped projection 316A is attached to the inner surface of the first head 310A. The mating half of the snap fit coupling system, e.g., locking recess, 316B is attached to the inner surface of the second head 310B and includes or is associated with a hole in the inner wall. In one arrangement, as shown in more detail in FIG. 4C and 4D, the locking recess can be formed by opposing cantilever mounted flexible arms 317A and 317B that are curved adjacent their distal ends. The sphere shaped projection 316A has an external profile to enable coupling and decoupling with locking recess 316B to be accomplished conveniently with pushing and pulling forces, respectively, in a manner known with snap fit coupling systems. That is, the leading ends of the arms 317A, 317B slide around the sphere 316A and flex away from each other during the insertion process and will slide back to their initial biased position when they slide over the midpoint of the sphere. The process happens in reverse during the decoupling process. It is recognized that other snap fit coupling configurations may be used.

The embodiments with the snap fit couplings can also include all of the components of the embodiment depicted in FIGS. 1A-3B. For example, the depicted illuminating device 300 may include a first head 310A, a second head 310B, a first neck 330A, a second neck 330B, and a base 360. The necks 330A, 330B may be joined together at 331 adjacent the base 360. Like the embodiment shown in FIGS. 1A-3B, the first neck 330A enables the first head 310A to be adjustably positioned relative to the base 360. Likewise, the second neck 330B enables the second head 310B to be adjustably positioned relative to the base 360 and the first head 310A. Additionally, the top surfaces of the heads 310A and 310B can include at least one visual alignment feature 319A, 319B as previously described. Further, any of the above illustrative head coupling systems and associated features can be used by themselves or in combination with the connections disclosed herein or with any other suitable method.

### Necks

FIGS. 1A-1B, 2A-2B, and 3A-3B show necks 130A, 130B attached at one end to the light source housings 115A, 115B and at their other ends to a common base 160. The location of attachment between light source housings 115A, 115B and the first end of a respective the neck 130A, 130B can be at the rear side of the housings 115A, 115B. However, the attachment point can be at an alternate position if desired. Any conventional attachment technique may serve as an adequate attaching mechanism for connecting the necks 130A, 130B to the housings 115A, 115B. For example, the mechanisms may include gluing, screwing, melting, bonding, clamping, hinging or squeezing so as to affix light source housings 115A, 115B to the ends of necks 130A, 130B.

The second ends of the necks 130A, 130B can be connected to the base 160 using any attachment arrangement discussed above for attaching the first end of the necks 130A, 130B to the heads 110A, 110B. If desired, and as is depicted in the figures, the external portion of the flexible necks 130A, 130B are coupled together prior to base 160 at location 131, 231 so that the two necks can be a single element for assembly purposes.

As previously described, the flexibility of the necks 130A, 130B enables the heads 110A, 110B to be adjustably positioned relative to the base 160. In an illustrative arrangement, the necks 130A, 130B are universally adjustable elongated flexible connecting structures. In this embodiment, the necks 130A, 130B lack predetermined fixed pivots and are not bound to a finite number of positions. In the embodiment depicted in FIGS. 1A-1C, the necks 130A, 130B may be twisted, bent, or rotated so as to allow 360° movement of neck 130.

The necks 130A, 130B may each be composed of several arm links, a rolled strip, or a tube-like housing around a wire, as well as numerous similar connecting members known in the art to provide flexible movement in all degrees of freedom. In alternate embodiments, not shown, the necks 130A, 130B may be formed by two or more rigid or semi-rigid members connected by hinges or by a telescopic arm. By affixing the heads 110A, 110B with the light sources, to one end of the necks 130A, 130B and the base 160 including the clamp 120 to second ends of the necks 130A, 130B, heads 110A, 110B, the heads 110A, 110B and the base 160 may be moved relative to each other enabling an almost infinite number of positions of the light sources. The positioning of the heads 110A, 110B are universally adjustable relative to the base 160 and merely bound by the length of the necks 130A, 130B.

The necks 130a, 130b may be of any desirable length. In a first arrangement, the necks 130a, 130b are between 3 and 15 inches in length. In an alternate arrangement and as a subset of the first arrangement, the necks 130a, 130b are between 3 and 10 inches in length. In yet another arrangement and as a subset of the prior described arrangements, the necks 130a, 130b are between 4 and 8 inches in length.

### Clamp

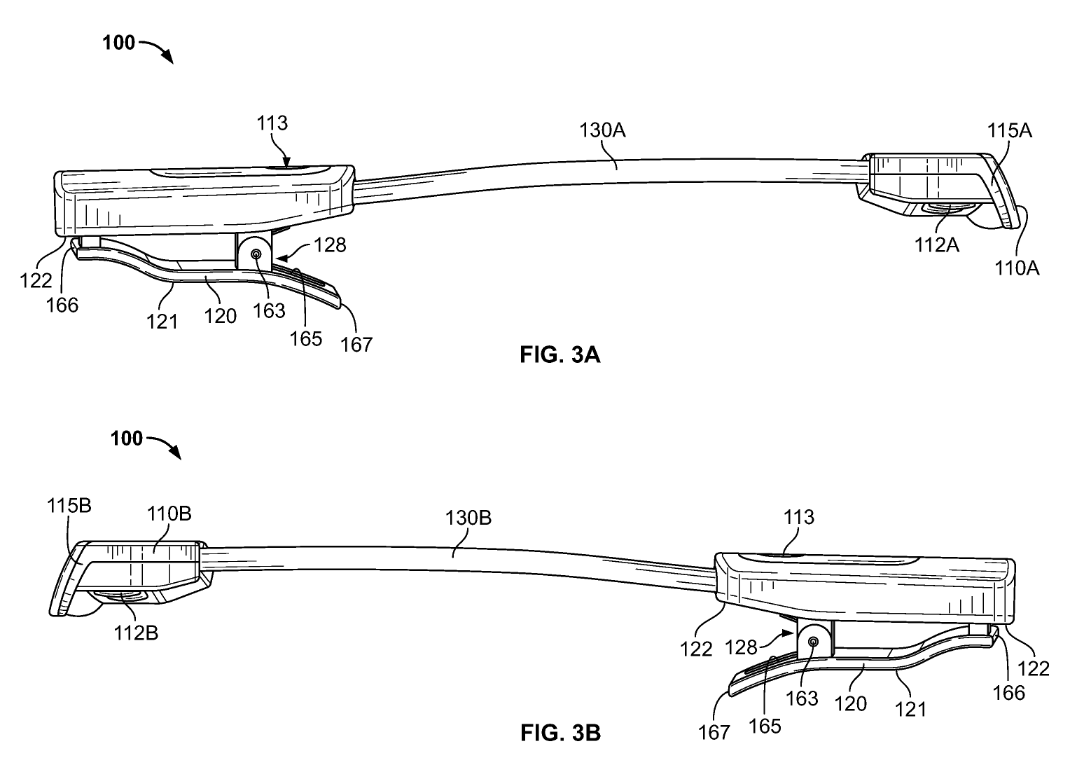

As seen in FIGS. 3A-3B, the base 160 includes a clamp 120. Generally, the clamp 120 has a clamped position and an open position. The clamp 120 is capable of attaching, grasping or securing itself to a number of structures, for example books, tables, laptop computers, automobile visors, automobile dashboards, poles and seemingly any other object to which an illuminating device 100 may be affixed when clamp 120 is in a clamped position. In the illustrative depicted arrangement, the clamp 120 includes two clamping members, a first member 121 and a second member 122. The first member 121 and second member 122 are movably coupled to one another. In the embodiment as shown in FIGS. 3A and 3B, the second clamping member 122 is the bottom surface of the base 160, and the first clamping member 121 moves relative thereto. In various embodiments, interior surfaces of the first member 121 and the second member 122 may include clamp assisting element(s)(not shown) to facilitate the grip of the first member 121 and the second member 122 on the object to which it is clamped. For example, rubber or plastic teeth may be placed along one edge of the clamp 120 or a patch of rough textured material may be adhered to one or both of the interior surfaces of the first member 121 and the second member 122.

In the illustrative arrangement, the first member 121 and the second member 122 are pivotally coupled to each other. In the depicted embodiment, this coupling arrangement is achieved by providing a pivoting mechanism 128. The pivoting mechanism 128 can be formed of any of a number of conventional pivoting mechanisms including pins, pivots, hinges, spring assemblies, etc.

Clamp 120 also may utilize a biasing member 165 depicted in part in FIGS. 3A-3B to provide a resistive force for clipping or affixing clamp 120 to an object, which is also biasing the clamp members 121 and 122 toward the neutral clamped position. The biasing member 165 may include any mechanism known in the art for supplying a resistive or biasing force. In the embodiment depicted in FIGS. 3A-3B, the biasing member 165 may include one or more torsion springs (not shown) placed at points of interaction between the aforementioned first member 121 and the second member 122 to provide a rotational force. However, the biasing member 165 may alternatively be placed in a number of other locations depending on the physical layout of the support member 120. In a preferred embodiment biasing member 165 biases by a rotational force on members 121 and 122 to put clamp 120 in a default closed position as depicted in FIGS. 3A-3B. Numerous other conventional biasing mechanisms are possible.

The pivot arrangement preferably forms a pivot axis 163 about which at least one member pivots relative to the other. In the illustrative arrangement, the first member 121 can be said to pivot relative to the second member 122. The biasing arrangement is such that the one side of the clamping members 121 and 122 can be used to clamp an object there between in clamping region 166. The biasing force caused by the biasing member is sufficient to, in the absence of significant counterforces, clamp and retain a portion of an object between the members 121 and 122. The biasing force can be overcome by applying a counter-force at the side 167 of the first member 121, which is opposite from the clamping region 166 relative to the pivot axis/fulcrum 163, and the first member 121 will pivoted to open the clamping region 166.

The clamping members 121 and 122 are made from any number of materials that would be used by one skilled in the art, including plastics, metals, and other materials used for such components. While the general footprint shapes of members 121 and 122 in FIGS. 1A-1C are depicted as being generally complimentary, it is understood that the footprint and/or sizes of the members 121 and 122 may be incongruous and may take on any of a number of shapes.

### Power Source, Switch, and Lighting System

In the illustrative arrangement, the light source is part of a lighting system that may also include electronic components used to emit the light including power sources such as one or more batteries, connecting circuitry conventionally used in light sources, especially portable light sources, and a controllable switching device, discussed below.

A battery compartment is operatively connected to the illuminating components (e.g. LED) within the heads 110A, 110B via the necks 130A, 130B so as to provide power to these components. As described earlier, the necks 130A, 130B may be configured to be flexed, rotated and moved in almost any direction. Accordingly, flexible wiring may be utilized within necks 130A, 130B to permit movement without obstructing electrical current flow to the heads 110A, 110B.

In an illustrative embodiment, the power source can be located in the base 160 and connecting wiring can extend through the necks 130A, 130B to couple the power source to the light sources. In this illustrative embodiment, the power source (e.g., the batteries) can be located in the base 160. The power source can be coupled to the applicable circuitry, switch, and light sources in the first head 110A and the second head 110B, through suitable wiring that can be routed through the first neck 130A and the second neck 130B to couple the power source to the remainder of the lighting elements.

In an illustrative alternative embodiment, these components may all be contained on or in the housings 115A, 115B. In one arrangement, the housings 115A, 115B, and more specifically the transparent sections 112A, 112B, may include the power source, electrical components and other structural components that affix or secure the aforementioned electrical components as well as other components within light source housings 115A, 115B. Components used in emitting light may be housed within or located on the light source housings 115A, 115B.

A controllable switching device in the form of a user engagable control mechanism 113 is included on the base 160 in the depicted embodiments. In the illustrated illustrative embodiment, the user engagable control mechanism 113 (e.g., depressible button) is located on an upper section of the base 160. However, the control mechanism can be located at any suitable location. For example, the user engagable control mechanism 113 can be located at a different positions on the surface of the base 160 such as on its side or the engagable control mechanism 113 can be located on the first housing 115A or the second housing 115B in the form of two switches controlling each light source independently or a unitary switch controlling both light sources.

In illustrative arrangements and as shown in FIGS. 1A-1B, the user engagable control mechanism 113 is a depressible button type switch located on the top of base 160. A user may depress the depicted button to control the light source between at least “ON” and “OFF” states as desired. Additionally, in an alternative control embodiment, in addition to an “OFF” state and an “all heads ON” state, there is a “first head only ON” state, and a “second head only ON” state. Such button control switches are known in the switching art and may include a suitable biasing device and circuitry to accomplish switching. In the illustrative embodiments of FIGS. 1A-1B, the depressible button 113 is raised from the surrounding region on the housing 115.

In lieu of the depicted depressible button, user engagable control mechanism 113, may be any of a number of switching mechanisms including switches, slide bars, toggles, and linearly slidable elements to allow the user to control light source housings 115A, 115B. For example, a user may interact with user engagable control mechanism 113 to adjust the brightness, permit intermittent light to be emitted, and turn the light source housings 115A, 115B “ON” and “OFF”.

### Operation

The illuminating device 100 is generally operable with its heads in two alternative configurations. In the first configuration, as depicted in FIGS. 1A and 2A, the device can be used as a single light unit wherein the housings 115A, 115B are connected to form one light source. In the second configuration, as depicted in FIGS. 1B and 2B, the housings 115A, 115B are uncoupled from each other such that each corresponding light source can be individually directed toward a particular area. In either of these two configurations, the illuminating device 100 is configured to allow the manipulation of the heads 110A, 110B into virtually any position with respect to the body 120 within the reach and bending limits of the necks 130A, 130B. In this regard, the illuminating device 100 enables numerous illuminating positions, and the illuminating device 100 further possesses variability based upon the user's preferences regarding amount, brightness, intensity and direction of lighting provided.

As described herein, the illuminating device 100 may perform numerous functionalities. For example, the clamp 120 allows the illuminating device 100 to be affixed to numerous structures, enabling use of the illuminating device in locations that are often more difficult to illuminate and that lack adequate lighting. More specifically, clamp 120, in certain embodiments, may be used to clip or clamp onto a structure in the area of desired illumination. The clamp 120 may be used to affix the illuminating device 100 to countless surface and structures. The illuminating device 100 may also be hung, affixed directly to or placed beside, any area of intended illumination. For example, the clamp 120 may be clipped onto the cover of a book, the edge of a desk, onto a laptop or notebook computer, around a pole, or even the fold down tray of an airplane cabin seat, etc.

To affix the illuminating device 100 to a particular structure, a user may apply a force at the side 167 which is opposite the clamping region 166 relative to the pivot axis 163. The force may be applied at the location of the grip enhancing region. The force should be sufficient to overcome the pivotal biasing force urging the members 121 and 122 into a clamping position. In particular, the force may be exerted on both members 121 and 122, thereby causing the clamp 120 to have a modified position from a neutral/clamped position to a more open position. While still applying the illustrative squeezing force, a user may then position clamp 120 so that the interior surfaces of the members 121 and 122 border the surfaces of the structure to which the illuminating device is to be affixed. Once interior surfaces border the structure the illuminating device is to be affixed to, the user then releases clamp 120, thereby eliminating an opposing force that was countering the biasing force. The biasing force will then cause clamp 120 to clamp onto a given structure at clamping region 166.

As described, illuminating device 100 may be utilized, among other things, as a book light. In such use, illuminating device 100 may be decorated and designed with numerous aesthetic features, including decorative shapes, contours, shadings, colors or designs. These decorative features, that may be placed on, or formed as part of, light source housings 115A, 115B, clamp 120 and/or necks 130A, 130B to name a few components and may encompass a seemingly limitless list of decoration, and thus are not described in specifics herein. As previously described, components of illuminating device 100 may have varied characteristics depending on the desired functionality and appearance. For example, each of light source housings 115A, 115B, clamp 120, and necks 130A, 130B may have varied physical, material, and functional aspects. Similarly, the orientation or manner of connection of heads 110A, 110B, necks 130A, 130B and base 160 may be varied.

Three or More Two Heads with Lighting Units

The embodiments of FIGS. 1A-4B reflect embodiment that include two light source housings. However, alternative embodiments reflect three and more than three light source housings. FIGS. 5A and 5B disclosures an illustrative illuminating device 500, with three heads 510A, 510B, and 510C with respective necks 530A, 530B, and 530C are used. Each of the three heads 510A, 510B, and 510C has a respective housing 515A, 515B, and 515C with one or more respective light sources (not shown) capable of transmitting light through a respective transparent section on the housing as previously described. The necks 530A, 530B, and 530C are all coupled to a common base 560. The base 560 has a clip (not shown) on its underside. Each neck 530A, 530B, and 530C enables its respective head 510A, 510B, 510C to be adjustably positioned relative to the base 560 and adjustably positioned relative to the remaining heads. Further, as described, the necks 530A, 530B, and 530C may be joined a location 531 adjacent the base 560. If desired, the clip may be similar or identical to the clip 120 shown FIGS. 2A, 2B, 3A and 3C.

In such an arrangement, each coupling of any two or more heads results in the capability of adjusting those coupled heads together as a single illumination unit. The coupled heads would exhibit the combined illumination characteristic according to a predetermined illumination characteristic formed by the combination of those heads. Any uncoupled head, including all of the heads when they are all uncoupled, enables the user to separately adjust the position and the angles of the heads to illuminate desired areas. With three or more heads, it is therefore possible to have all the heads coupled together, a selected two of the heads coupled together, or all the heads uncoupled. Any of the illustrative head coupling systems described and/or depicted herein can be used for this coupling system.

Additionally, this embodiment includes features as has been described with respect to the other disclosed embodiments. For example, in one arrangement, the illuminating device 500 includes a visual alignment system formed by regions 519A, 519B, and 519C on the top surfaces of the housing 515A, 515B, and 515C to aid in the coupling process. Further, the illuminating device 500 preferably includes a control and power system and is operated the same or similar to the manner that was described with respect to the other embodiments. For example, an user engagable control mechanism 513 on the base 560 may be used to control turn the illumination members on the heads on and off, either all together, or an cycle through various states of all ON, all OFF, and the combinations of the lights being ON and OFF.

While the invention has been described with respect to specific examples including presently preferred modes of carrying out the invention, those skilled in the art will appreciate that there are numerous variations and permutations of the above described systems and techniques. For example, the embodiments depicted in the figures reflect illustrative industrial designs. However, there are numerous variations of industrial design that embody elements and combinations of elements of the disclosure. Thus, the spirit and scope of the invention should be construed broadly as set forth in the appended claims.

We claim:

1. An illuminating device comprising:
a first housing, the first housing including a first light source therein;
a second housing, the second housing including a second light source therein;
a base, the base being configured to permit removable attachment to an article;
a first neck, the first neck being attached at a first end to the first housing and at a second end to the base and enabling the first housing to be adjustably positioned with respect to the base;
a second neck, the second neck being attached at a first end to the second housing and at a second end to the base and enabling the second housing to be adjustably positioned with respect to the base; and
the first housing and the second housing being configured to be removably coupled to each other to enable movement of the first and second housing together when coupled, and to be individually manipulated when uncoupled.

2. The illuminating device of claim 1, wherein the base includes a clamp having first and second members for clamping an article there between, and a biasing device for providing a biasing force to clamp an object between the first and second members, and wherein the first neck and the second are elongated bendable flexible elements.

3. The illuminating device of claim 1, wherein the first housing includes a magnet and the second housing includes one of a magnet or a magnet-attracting material so that the first and second housings may be removably coupled together by a magnetic attachment system.

4. The illuminating device of claim 1, wherein the first housing and the second housing each include a part of a hook and loop attachment system to enable the first and second housings may be removably coupled together.

5. The illuminating device of claim 1, wherein the first housing and the second housing each include a part of a snap fit attachment system to enable the first and second housings may be removably coupled together.

6. The illuminating device of claim 1, wherein the first and second necks are coupled together adjacent to and exterior to the base.

7. The illuminating device of claim 1, wherein the base includes a battery and a user-engagable control switch.

8. The illuminating device of claim 1, further comprising a third housing including a third light source therein, the third housing being configured to be removably attached to the first housing or the second housing such that the first light source, the second light source, and the third light source can form a unitary light source or be separately focused on one or more areas.

9. The illuminating device of claim 1, further comprising visual elements on the exterior of the first and second housings to assist in the alignment of the first and second housings.

10. The illuminating device of claim 9, wherein the visual elements on the first and second housing include one of surface ornamentation, a contrast of colors, a contrast of surface finishes.

11. The illuminating device of claim 10, wherein the visual elements on the first and second housing are located on a side on their first and second housings opposite from their light source.

12. The illuminating device of claim 1, further comprising a projection on the first housing and a complementary-shaped alignment groove on the second housing.

13. The illuminating device of claim 1, wherein the length of the first neck is between 3 and 10 inches and the length of the second neck is between 3 and 10 inches.

14. An illuminating device comprising:
a first housing, the first housing including a first light source therein;
a second housing, the second housing including a second light source therein;
a base, the base including a battery operatively connected to the first and second light sources, and a user-engagable control switch;
a flexible first neck, the first neck being attached at a first end to the first housing and at a second end to the base and enabling the first housing to be adjustably positioned with respect to the base and with respect to the second housing;
a flexible second neck, the second neck being attached at a first end to the second housing and at a second end to the base and enabling the second housing to be adjustably positioned with respect to the base and with respect to the first housing; and
attachment means for removably coupling the first housing to the second housing.

15. The illuminating device of claim 14, wherein the base includes a clamp having first and second members for clamping an article therebetween.

16. The illuminating device of claim 15 wherein the attachment means is selected from one or more of the group consisting of magnetically-attracting elements, elements of a hook and loop attachment system, and elements for a snap-fit attachment.

17. The illuminating device of claim 14, further comprising a third housing including a third light source therein and a flexible third neck, the third neck being attached at a first end to the third housing and at a second end to the base and enabling the third housing to be adjustably positioned with respect to the base and with respect to the first and second housing; and wherein the third housing is configured to be removably coupled to the second housing to enable movement of the first, second, and third housings together when coupled, and to be individually manipulated when uncoupled.

18. An illuminating device comprising:
a first housing, the first housing including a first light source therein, and a first coupling element;
a second housing, the second housing including a second light source therein, and a second coupling element;
a base, the base having a clamp with first and second members for removably clamping an article therebetween;
a first neck, the first neck being attached at a first end to the first housing and at a second end to the base, having a length between 3 and 10 inches, and enabling the first housing to be adjustably positioned with respect to the base;
a second neck, the second neck being attached at a first end to the second housing and at a second end to the base, having a length between 3 and 10 inches, and enabling the second housing to be adjustably positioned with respect to the base; and
the first housing and the second housing being configured to be removably coupled to each other based on the relationship of the first and second elements to selective permit the coupling and decoupling of the first and second housing to each other and thereby enable movement of the first and second housing together when coupled, and to be individually manipulated when decoupled.

19. The illuminating device of claim 18, wherein the first and second elements are at least one of (a) magnetically attractive to each other, (b) complementary snap-fit elements, and (c) mating pairs of a hook and loop attachment system.

20. The illuminating device of claim 19, further comprising a housing visual alignment system, and a projection on the first housing and a complementary-shaped alignment groove on the second housing.
